(19) United States
(12) Patent Application Publication
(10) Pub. No.: US 2002/0139646 A1
(43) Pub. Date: Oct. 3, 2002

(54) Circuit breaker lockout device

(76) Inventor: Robert Frank Karlicek, Fullerton, CA (US)

Correspondence Address: Robert F. Karlicek, 1920 Camino Centroloma, Fullerton, CA, 92833, US

(21) Appl. No.: 09/823,346

(22) Filed: Apr. 2, 2001

Related U.S. Application Data
(60) Provisional application No. 60/228,290, filed on Aug. 28, 2000.

(51) Int. Cl. H01H 9/28

(52) U.S. Cl. 200/43.14

(57) ABSTRACT

The invention described herein comprises a lockout device that is permanently attached to a circuit breaker or on the panel to which the circuit breaker is attached to provide a means of physically locking the operating handle of the circuit breaker in the OFF (open) position. It includes a lockout bar that can be rotated to the unlocked position so that the operating handle can be moved to allow manual operation of the circuit breaker to either the ON (closed) or OFF (open) position. A hasp is provided to facilitate the use of a standard padlock to lock the circuit breaker in the OFF (open) position Two versions for mounting the device are included; namely, one version for locking out one or more circuit breakers in a group of circuit breakers, and a second version for locking out a single circuit breaker.

This application references provisional Patent Application No. 60/228,290, filed on Aug. 28, 2000, entitled Circuit Breaker Lockout Device.

### BACKGROUND OF THE INVENTION

This invention relates to a device which makes it possible to physically lock the operating handle of a circuit breaker in the open position. The ability to lock a circuit breaker in the open position is often required to ensure that the electrical circuit supplying power to specific equipment is open so that people can safely work on the equipment. The operating handles of some circuit breakers are designed so that padlocks can be attached to physically lock the handle in the open position; however, circuit breakers not designed with this locking feature require an external locking device. Devices which clamp or otherwise attach to the operating handle of the circuit breaker are currently available; however, such devices when removed are often lost or misplaced so that they are not available when needed. This invention provides a lockout device consisting of the following:

A means of mounting the device on the circuit breaker or the panel to which the circuit breaker is attached so that the lockout device is dedicated to the circuit breaker and there is no need to remove it to operate the circuit breaker.

A lockout bar which in the lockout position will keep the circuit breaker in the OFF (open) position by preventing the movement of the operating handle to the ON (closed) position. The lockout bar can be rotated to the unlocked position so that the operating handle can be moved to allow manual operation of the circuit breaker to either the OFF (open) or ON (close) position.

A hasp which facilitates the use of a standard padlock to lock the circuit breaker in the OFF (open) position.

The preferred embodiment of the invention describes two versions; namely, one version applied to a group of circuit breakers, and a second version for locking out a single circuit breaker.

### SUMMARY OF THE INVENTION

The invention described herein comprises a lockout device that is permanently attached to a circuit breaker or on the panel to which the circuit breaker is attached to provide a means of physically locking the operating handle of the circuit breaker in the OFF (open) position. It includes a lockout bar that can be rotated to the unlocked position so that the operating handle can be moved to allow manual operation of the circuit breaker to either the ON (closed) or OFF (open) position. A hasp is provided to facilitate the use of a standard padlock to lock the circuit breaker in the OFF (open) position. Two versions for mounting the device are included; namely, one version applied to a group of circuit breakers, and a second version for locking out a single circuit breaker.

### DESCRIPTION OF THE DRAWINGS

FIG. 1 is a front view of a lockout device of this invention for a group of circuit breakers, including three sectional views.

FIG. 2 is a front view of a lockout device of this invention for one circuit breaker, including one sectional view.

### DETAILED DESCRIPTION

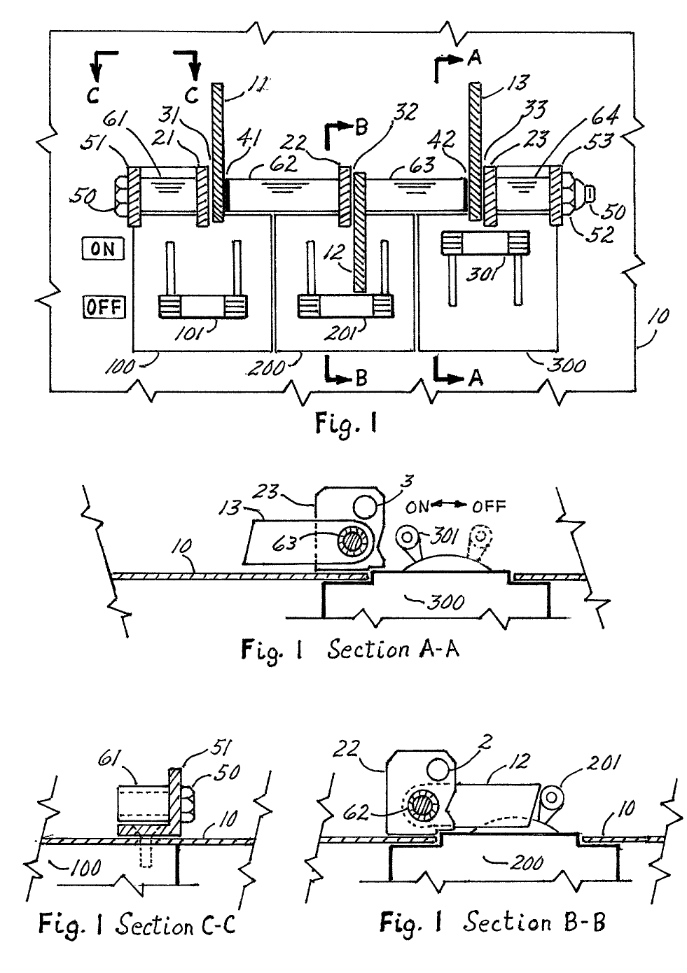

The preferred embodiment of this invention is described in this section; however, it should be understood that there may be other ways of practicing the invention and that the embodiments described herein are exemplary and not limiting. FIG. 1 is a front view of a lockout device for a group of circuit breakers showing circuit breakers 100, 200 and 300 mounted on panel 10. Operating handles 101 and 201 of circuit breakers 100 and 200, respectively, are shown in the OFF (open) position; whereas, operating handle 301 of circuit breaker 300 is shown in the ON (closed) position.

The lockout device is comprised of the assembly of components mounted above the circuit breakers. The assembly is held together by bolt 50 extending through all the components and lock nut 52 which is tightened to secure the assembly with proper force to allow rotation of lockout bars 11, 12 and 13. In FIG. 1, two lockout bars 11 and 13 are shown in the unlocked position demonstrating that the associated circuit breaker operating handles 101 and 301 can be in the (ON) or (OFF) position. Section A-A in FIG. 1, shows that when lockout bar 13 is in the unlock position above circuit breaker 300, it does not interfere with moving operating handle 301. Section B-B in FIG. 1 shows lockout bar 12 rotated to the lockout position in front of operating handle 201. Insertion of a shackle of a standard padlock in hole 2 in hasp 22 prevents rotation of lockout bar 12 from the lockout position which prevents moving operating handle 201 to the ON position; thus, locking circuit breaker 200 in the OFF position It should be understood that lockout bars 11, 12 and 13 can be rotated independent of each other so that none, any one, or all of the circuit breakers can be locked in the OFF position.

Right angle bracket 51 shown in Section C-C in FIG. 1 and right angle bracket 53 (similar to bracket 51, but not shown) are provided for mounting and are fastened to panel 10 before assembly of the components. Spacers 61, 62, 63 and 64 are rods which slip over thru-bolt 51 and provide the desired locations for lockout bars 11, 12 and 13. A thin nylon washer 31, 32 and 33 is provided between each hasp and lockout bar to provide smooth rotation of the lockout bars. Disc spring washers 41 and 42 are provided as shown in FIG. 1 to provide compression force on the assembly so that the lockout bars maintain their position while permitting easy rotation of them by hand.

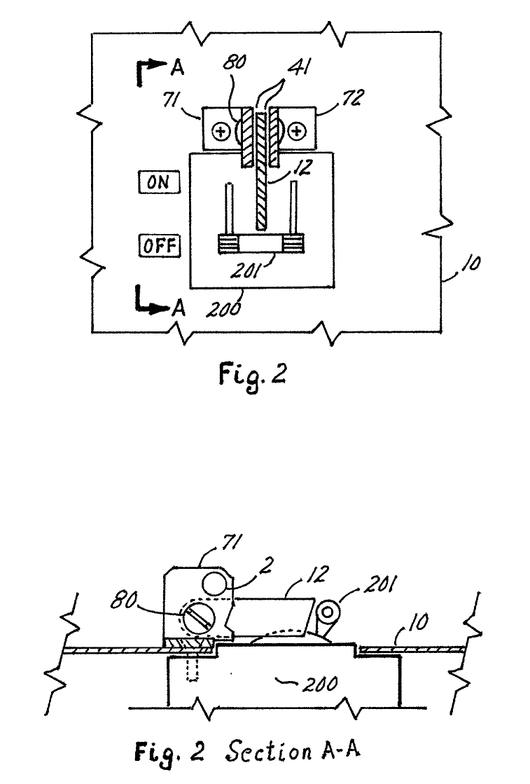

FIG. 2 shows a lockout device for a single circuit breaker 200 attached to panel 10. The operation of the device is similar to that described above for a group of circuit breakers. The assembly of components is mounted to panel 10 using two right angle brackets 71 and 72, which are held together by binding screw 80. Two disc spring washers 41 are located between angle brackets 71 and 72 and lockout bar 12 to provide compression force on the assembly so that the lockout bar maintains its position while permitting easy rotation by hand.

Right angle brackets 71 and 72 are each provided with hole 2 so that they function as hasps as shown in Section A-A in FIG. 2. Insertion of a shackle of a standard padlock in hole 2 prevents rotation of lockout bar 12 from the lockout position which prevents moving operating handle 201 to the ON position; thus, locking circuit breaker 200 in the OFF position.

While the foregoing is a detailed description of the preferred embodiment of the invention, the claims which follow define the general scope of invention. Modifications or improvements in the preferred embodiments should be treated as within the scope of invention insofar as they are equivalent or otherwise consistent with the contribution over prior art.

I claim:

1. Apparatus attached to a circuit breaker or on the panel to which the circuit breaker is mounted providing means for locking a circuit breaker in the OFF (open) position and which provides means to operate the circuit breaker without removal of the lockout apparatus.

2. Apparatus in claim 1 wherein a lockout bar can be rotated by hand to a lockout position or to an unlocked position such that in the lockout position it prevents moving the operating handle of the circuit breaker to the ON (closed) position, and when in the unlocked position, it allows moving the operating handle of the circuit breaker to either the OFF (open) or ON (closed) position.

3. Apparatus in claim 1 wherein a hasp provides means to use a standard padlock to lock the circuit breaker in the OFF (open) position.
